(19) United States
(12) Patent Application Publication
(10) Pub. No.: US 2016/0309124 A1
(43) Pub. Date: Oct. 20, 2016

(54) CONTROL SYSTEM, A METHOD FOR CONTROLLING AN UAV, AND A UAV-KIT

(71) Applicant: ZEROTECH (Shenzhen) Intelligence Robot Co., Ltd., Shenzhen (CN)

(72) Inventors: Jianjun Yang, Beijing (CN); Hongtao Sun, Beijing (CN)

(21) Appl. No.: 15/096,283

(22) Filed: Apr. 12, 2016

(30) Foreign Application Priority Data
Apr. 20, 2015 (CN) 201510189111.6

(51) Int. Cl. H04N 7/18; H04N 5/232; G08G 5/00; G06K 9/00; H04B 7/185; H04W 4/00

(52) U.S. Cl. CPC H04N 7/185; H04B 7/18506; H04W 4/006; G08G 5/0086; G06K 9/0063; H04N 5/23203; B64C 2201/127

(57) ABSTRACT

A control system, a method for controlling an unmanned aerial vehicle (UAV), and a UAV-kit are provided. The control system includes an UAV configured to capture an image and transmit the captured image signal. The control system further includes a mobile terminal, wirelessly connected to the UAV, configured to receive the transmitted image signal and send a control signal to the UAV. The mobile terminal includes a pattern recognition data processing module for processing image captured by the UAV.

### CROSS-REFERENCE TO RELATED APPLICATIONS

The present application is based on, and claims priority from, China Application Serial Number 201510189111.6, filed on Apr. 20, 2015, the disclosure of which is hereby incorporated by reference herein in its entirety.

### TECHNICAL FIELD

The present disclosure relates to a control system, a method for controlling an unmanned aerial vehicle, and a UAV-kit.

### BACKGROUND

With the continuous development of aviation technology, aerial apparatuses have been widely used in military and civilian fields, aerial apparatus refers to an aircraft or unmanned aerial vehicles (UAVs) and other aerial devices with flight capabilities and so on. Aerial apparatus has been widely used in geological disaster monitoring, forest fire prevention, aerial mapping, environmental monitoring and detection of target and other fields.

In the meantime, there are increasingly higher requirements for UAVs' intelligent flight image capture, such as UAVs' capability of targeting and tracking an object on the ground or in the air. In particular, based on visual technology, target recognition and tracking algorithms, UAVs can perform local intelligent flight, thereby enhancing the UAVs' capability to automatically perform image capture.

A typical UAV obtains video signal by a camera device inside the UAV, and processes data by an on-board digital signal processor (DSP) configured in the body of the UAV. Additionally, a ground station may monitor the UAV's operation. By such a configuration, a separate image processing device, such as an image processing DSP circuit board, has to be set on the UAV.

### SUMMARY

An example control system of the disclosure includes an unmanned aerial vehicle (UAV) configured to capture an image and transmit the captured image signal. The control system further includes an image processing terminal, wirelessly connected to the UAV, configured to receive the transmitted image signal and send a control signal to the UAV. The image processing mobile terminal comprises a pattern recognition data processing module for processing image captured by the UAV.

An example method for controlling an UAV includes capturing an image by the UAV and transmitting the captured image signal from the UAV to a mobile terminal or a ground receiver. The method further includes executing in the mobile terminal a pattern recognition data processing based on the transmitted captured image signal, and sending a control signal from the mobile terminal to the UAV based on the pattern recognition data processing. The method further includes performing image capturing by the UAV based on the control signal from the mobile terminal.

An example UAV-kit includes an UAV configured to capture an image and transmit an image signal. The UAV-kit also includes a mobile terminal, wirelessly connected to the UAV, configured to execute a pattern recognition data processing based on the transmitted image signal and send a control signal sent to the UAV based on the pattern recognition data processing.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain principles of the invention.

### BRIEF DESCRIPTION OF THE FIGURES

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a diagram of a control system within which embodiments of the invention may be implemented.

FIG. 2 is a flowchart of an example method for controlling an UAV, according to embodiments of the invention.

FIG. 3 is a flowchart of another example method for controlling an UAV, according to embodiments of the invention.

FIG. 4 is a flowchart of another example method for controlling an UAV, according to embodiments of the invention.

The same reference numbers will be used throughout the drawings to refer to the same or like parts.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure. Readers of the following detailed description should, therefore, not interpret the description in a limiting sense, and only the appended claims define the scope of the embodiment of the disclosure.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

As noted in the background section, in a typical UAV, a processing device such as a DSP is additionally set in the UAV for image processing. The present inventors have recognized that such configuration may increase the weight of the UAV, accordingly, the UAV's carrying capacity, flexibility and battery life are adversely affected. Further, configuring a separate processing device in the body of the UAV will cause extra components to be integrated in the UAV and more connection lines need to be set up. Thus, the complexity of the UAV are increased. For example, the operation of the typical UAV requires a cooperation across multiple components including DSP blocks, ground station computers and the corresponding connection lines etc., which will increase the difficulty of debugging, operation and failure probability. Eventually, this complexity results in higher costs to users.

Disclosed herein are techniques to address these problems mentioned in the background part. Instead of providing an image processing/pattern recognition module inside UAV itself, in accordance with the techniques disclosed herein, the control method and system of unmanned aerial vehicles is configured to conduct image processing/pattern recognition outside of UAV. Specifically, in order to achieve intelligent flight image shooting, drone captured image will be transmitted to the mobile terminal, and data processing pattern recognition will be conducted on an independent terminal.

On one hand, the overall structure of UAVs is simplified because processing modules are taken out from UAVs, which improves carrying capacity, flexibility, and battery life of UAVs and reduces failure rate of UAVs. On the other hand, by separating out said processing modules for image processing from UAVs, it facilitates image processing modules' hardware/software upgrades or expansion. Further, it makes a more simple operation of UAVs' users and a better user experience.

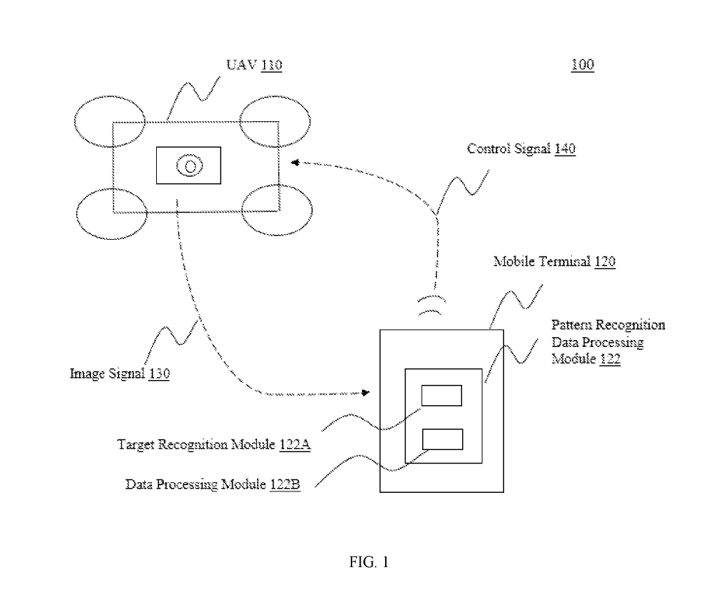

FIG. 1 is a diagram schematically illustrating an example control system 100 within which embodiments of the invention may be implemented. As depicted in FIG. 1, the system 100 includes an UAV 110 and a terminal 120, which is a mobile terminal. The UAV 110 and the mobile terminal 120 may be connected and communicated with each other in a variety of manners. For example, the connectivity and communication of the UAV 110 and the mobile terminal 120 can be performed via mechanisms including, but not limited to, WiFi (e.g., IEEE 802.11), 3G/4G network.

The UAV 110 represents an aircraft without a human pilot aboard. The flight of UAV 100 may be controlled with various kinds of autonomy. It may be operated either by a given degree of remote control from a user, located on the ground or in another vehicle, or fully autonomously, by onboard computers. Further, in order to fully operate and extend its capability, the UAV 110 may be programmed with various computer software and carry payloads such as cameras, power supply, sensors, actuators. For example, the UAV 110 can be configured with an image capturing component, such as a camera, to capture an image during a flight in civilian or military use.

In the embodiment of FIG. 1, the UAV 110 is configured without an image processing component, such as a DSP. Instead, the UAV 110 captures an image via a camera and transmits the captured image signal 130 to a separate device of the system 100, for example, the mobile terminal 120. Thus, the processing of the captured image is not performed within the UAV 110 but in another device of the system 100. The transmission of the captured image signal 130 from the UAV 110 to the mobile terminal 120 is through a variety of manners, for example, wireless transmission including but not limited to WiFi, Bluetooth cellular network, an orthogonal frequency division multiplexing (OFDM) and other conventional manner, for example, 3G/4G network.

Upon receiving the captured image signal 130 transmitted from the UAV 110, the mobile terminal 120 will be responsible for performing subsequent operations, for example, processing the captured image signal 130 and sending a control signal 140 back to UAV 110. In the embodiment of FIG. 1, the mobile terminal 120 can execute a pattern recognition data processing based on the captured image signal 130 transmitted from the UAV 110 and send a control signal 140 to the UAV 110 based on the aforementioned pattern recognition data processing. The mobile terminal 120 may be a cell phone, a tablet or any other devices having capability of image processing without departing from the spirit or scope of the disclosure.

The mobile terminal 120 comprises a pattern recognition data processing module 122 for processing the captured image signal 130 by the UAV 110. For example, the pattern recognition data processing module 122 may be programmed to execute a method using specific techniques to analyze a variety of information regarding a target object and an environment. Said technique might be chosen from optical information recognition, visual intelligent processing, etc. In the embodiment of FIG. 1, based on the captured image 130 by the UAV 110, data regarding the target object in the captured image 130 and environment is analyzed and processed by the terminal 120. Subsequently, based on the analysis and processing, the target object may be identified, located and tracked. Without departing from the spirit or scope of the disclosure, the pattern recognition data processing carried out by the mobile terminal 120 is not limited to the above described embodiments, the ordinary artisan should appreciate that in view of the current development of pattern recognition data processing technology, any further pattern recognition data processing related to the intelligent flight of UAV can be integrated into the mobile terminal 110.

In some embodiments, the pattern recognition data processing module 122 may further comprise sub-components to perform aforementioned intended operations. As depicted in FIG. 1, the pattern recognition data processing module 122 may comprise a target recognition module 122A and a data processing module 122B. In particular, the target recognition module 122A is configured to determine the target object, and the data processing module 122B is configured to process the captured image 130, obtain a coordinate data of the target object and send the coordinate data of the target object can be sent back to the UAV 110. In some embodiments, the movement information (e.g., speed, acceleration, direction, etc.) of target object is also calculated by the data processing module 122B.

The target recognition module 122A can determine the target object in a variety of ways. For example, once the captured image signal 130 transmitted by the UAV 110 is received by the mobile terminal 120, an user can directly choose the target object on the mobile terminal 120 based on the image signal 130. More specifically, the image 130 captured by the UAV 110 can be directly displayed on the mobile terminal 120, such as on the touch screen of a cell phone or a tablet. Thus, the user can designate the target object by directly clicking the touch screen.

However, the determination of the target object is not limited to the aforementioned manner. In alternative embodiments, a target object data is preset in the mobile terminal 120. For example, a target object image can be stored on the cell phone or the tablet, and the target object characteristic data can be extracted from the target object image, such as a human facial feature data, a human body feature data and/or a human gestures feature data, which can be used as the target object data. Then, the mobile terminal 120 receives the captured image 130 and matches the captured image 130 with the preset target object data. Based on the matching results, the mobile terminal 120 determines the existence of the target object. The data matching process can be, for example, a human face recognition, a human body characteristics recognition, a human gesture characteristics recognition. In other words, instead of manually operating the mobile terminal 120 by the user, determining the target object can be done by setting up a reference in advance.

Additionally or independently, in order to recognize a variety of information regarding the target object and environment, the target recognition module 122A may further comprise a human face recognition module, a human body characteristics recognition module and/or a human gesture characteristics cognition module. But the pattern recognition data processing module 122 is not limited to the aforementioned configuration. Depending on the type of the pattern recognition arising from actual needs, appropriate adjustment can be made to the configuration of the pattern recognition data processing module 120 without departing the spirit or scope of the disclosure.

Obtaining the coordinate data of the target object based on the image signal 130 is part of the pattern recognition data processing. As depicted in FIG. 1, this can be performed by the data processing module 122B. The obtained coordinate data of the target object can be a relative position coordinate of the target object from the center of the image captured by the UAV 110, wherein the target object is in the image captured by the UAV 110. Alternatively, the obtained coordinate data of the target object can be a coordinate data of the target object distant from a specified reference. It could also be different forms of coordinate data, such as coordinate data in polar form or in the form of spherical coordinates.

In some embodiments, the system 100 may further comprise one or more ground receiver. For example, instead of receiving the image signal 130 transmitted from the UAV 110 directly by the mobile terminal 120, the ground receiver is configured as an intermediate to receive the image signal 130 transmitted from the UAV 110 and relay the image signal 130 to the mobile terminal 120. The manner of signal transmission between the ground receiver and the mobile terminal 120 is dependent on actual demands and no specific limitations are set.

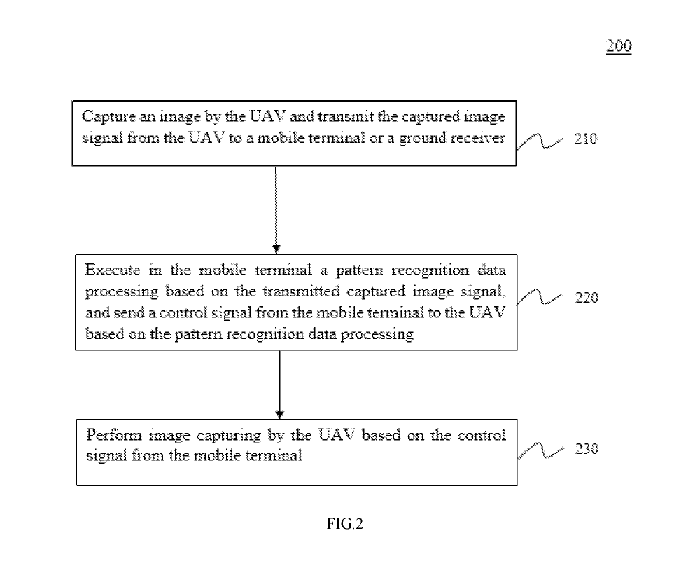

FIG. 2 illustrates an example method 200 for controlling an UAV. In step 210, an image is captured by an UAV and the captured image signal is transmitted from the UAV to a mobile terminal or a ground receiver. While the processes of capturing the image during the flight and transmitting the captured image are performed by the UAV, the process of analyzing the captured image is taken over by a separate device, for example, the mobile terminal 120 of FIG. 1. The transmission of the captured image signal from the UAV to the mobile terminal is through a variety of manners, for example, wireless transmission including but not limited to WiFi, Bluetooth cellular network, an orthogonal frequency division multiplexing (OFDM) and other conventional manner.

In step 220, a pattern recognition data processing is executed in the mobile terminal based on the captured image signal transmitted from the UAV. Based on the pattern recognition data processing, a control signal is sent from the mobile terminal to the UAV. The step 220 of executing the pattern recognition data processing may be performed in many manners.

In step 230, based on the control signal from the mobile terminal, the UAV will perform image capturing.

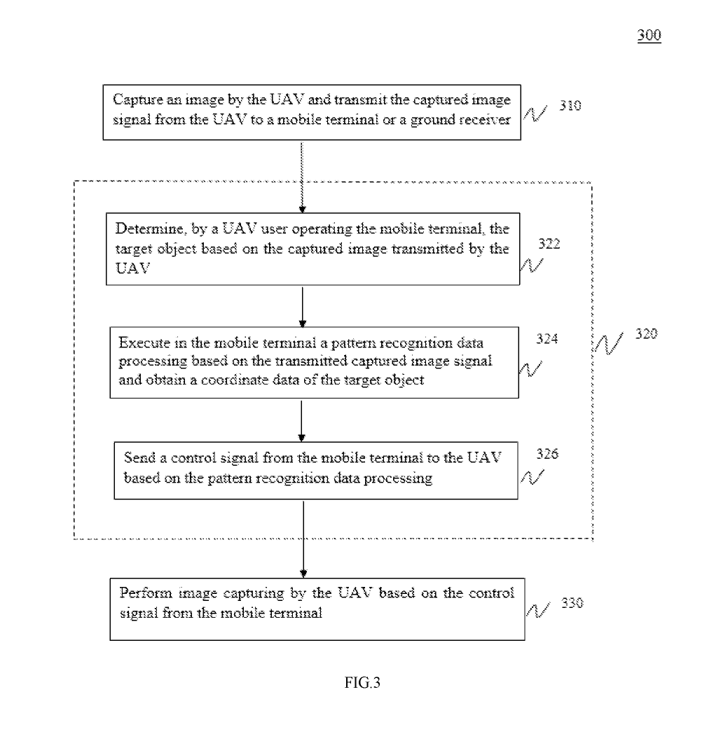

FIG. 3 illustrates another example method 300, as will be detailed below. In FIG. 3, steps 310 and 330 are substantially similar to steps 210 and 230 of FIG. 2.

In FIG. 3, step 320 have more sub steps. In step 322, based on the captured image transmitted by the UAV, the target object is determined by a UAV user operating the mobile terminal. For example, once the captured image signal transmitted by the UAV is received by the mobile terminal, the user can directly choose or identify the target object(s) on the mobile terminal based on the captured image signal. More specifically, the image captured by the UAV can be directly displayed on the mobile terminal, such as on the touch screen of a cell phone or a tablet. Thus, the user can designate the target object by directly clicking the touch screen.

In step 324, the pattern recognition based on the transmitted captured image signal is executed in the mobile terminal and a coordinate data of the target object is obtained. The obtained coordinate data of the target object can be a relative position coordinate data of the target object from the center of the image captured by the UAV, wherein the target object is in the image captured by the UAV. Alternatively, the obtained coordinate data of the target object can be a coordinate data of the target object distant from a specified reference. Moreover, other movement information (e.g., speed, acceleration, direction, etc.) of target object is also calculated in step 324.

In step 326, a control signal is sent from the mobile terminal to the UAV based on the pattern recognition data processing. As an example, the control signal may include the relative position coordinate data of the target object, or other flight instructions using such position of the target object.

In some embodiments, the UAV may adjust its flight movements (speed, acceleration, directions, orientation, etc.) based on the control signal. For example, the user can keep the target at the center of the captured image. In additional embodiments, the UAV is controlled to fly towards or against the target in specific direction, orientation or speed.

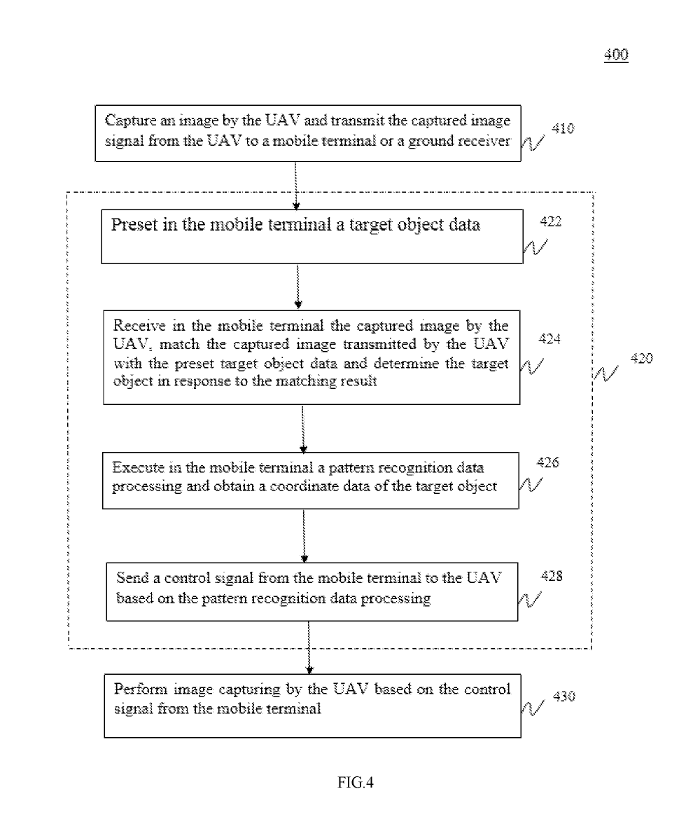

FIG. 4 illustrates another example method 400, as will be detailed below. In FIG. 4, steps 410 and 430 are substantially similar to steps 210 and 230 of FIG. 2. However, the step 420 of executing the pattern recognition data processing may be performed in a manner different from the aforementioned. In the example as depicted in FIG. 4, the step 420 may further comprise steps 422, 424, 426 and 428, as will be detailed below.

In step 422, a target object data is preset in the mobile terminal. For example, a target object image can be stored on the cell phone or the tablet, and the target object characteristic data can be extracted from the target object image, such as a human facial feature data, a human body feature data and/or a human gestures feature data, which can be used as the target object data.

Further, it is understood that there might be more than one target objects that are of interest. Thus, the user can choose more than one target objects out of the captured image. Also, a library of potential target objects are provided in advance.

In step 424, the captured image is received in the mobile terminal and a comparison is performed. Specifically, the captured image is matched with the preset target object data. Based on the matching results, the target object is determined by the mobile terminal. Further, if there is one or more potential hit from the matching step, one or more matching candidates are presented for subsequent step. The data matching process can be, for example, a human face recognition, a human body characteristics recognition, a human gesture characteristics recognition.

In step 426, the pattern recognition based on the transmitted captured image signal is executed in the mobile terminal and a coordinate data of the target object is obtained.

In step 428, a control signal is sent from the mobile terminal to the UAV based on the pattern recognition data processing. As an example, the control signal may include the relative position coordinate data of the target object, or other flight instructions using such position of the target object. For example, the user can keep the target at the center of the captured image. Alternatively, the UAV is controlled to fly towards or against the target in specific direction, orientation or speed.

In step 430, based on the control signal from the mobile terminal, image capturing is performed by the UAV. For example, based on the control signal from the mobile terminal, the UAV may track the target object and keep the target object in the center of the image captured by the UAV. Alternatively, the UAV is controlled to fly towards or against the target in specific direction, orientation or speed.

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the invention disclosed herein. It is intended, therefore, that this disclosure and the examples herein be considered as exemplary only, with a true scope and spirit of the invention being indicated by the following listing of exemplary claims.

What is claimed is:

1. A control system, comprising:
an unmanned aerial vehicle (UAV) configured to capture an image and transmit the captured image signal;
a mobile terminal, wirelessly connected to the UAV, configured to receive the transmitted image signal and send a control signal to the UAV;
wherein the mobile terminal comprises a pattern recognition data processing module for processing image captured by the UAV.

2. The system of claim 1, wherein the pattern recognition data processing module further comprises:
a target recognition module configured to determine a target object;
a data processing module configured to process the image, obtain a coordinate data of the target object and send the coordinate the data of the target object to the UAV.

3. The system of claim 2, wherein the coordinate data of the target object is a relative position coordinate data of the target object from the center of the image captured by the UAV.

4. The system of claim 2, wherein the mobile terminal is operated by a user to determine the target object.

5. The system of claim 2, wherein the target recognition module comprises a human face recognition module, a human body characteristics recognition module and/or a human gesture characteristics cognition module.

6. The system of claim 1, further comprising a ground receiver configured to receive the image signal from the UAV and relay the image signal to the mobile terminal.

7. The system of claim 1, wherein the UAV is configured to adjust its flight movements based on the control signal.

8. The system of claim 7, wherein the UAV is configured to track the target object based on the control signal so as to keep the target object in the center of the image captured by the UAV.

9. A method for controlling an UAV, the method comprising:
capturing an image by the UAV and transmitting the captured image signal from the UAV to a mobile terminal or a ground receiver;
executing in the mobile terminal a pattern recognition data processing based on the transmitted captured image signal, and sending a control signal from the mobile terminal to the UAV based on the pattern recognition data processing; and
performing image capturing by the UAV based on the control signal from the mobile terminal.

10. The method of claim 9, wherein executing pattern recognition data processing comprises:
determining a target object and obtaining a coordinate data of the target object.

11. The method of claim 10, wherein determining the target object comprises: determining, by a UAV user operating the mobile terminal, the target object based on the captured image transmitted by the UAV.

12. The method of claim 10, wherein determining a target object comprises:
presetting in the mobile terminal a target object data;
matching the captured image transmitted by the UAV with the preset target object data and determining the target object in response to the matching result.

13. The method of claim 12, wherein the target object data is human face characteristic data, human body characteristics data and/or human gesture characteristics data.

14. The method of claim 10, wherein the obtained coordinate data of the target object is a relative position coordinate data of the target object from the center of the image captured by the UAV, wherein the target object being in the image captured by the UAV.

15. The method of claim 9, wherein performing image capturing by the UAV comprises:
tracking the target object and controlling the UAV's movement based on the control signal so as to keep the target object in the center of the image captured by the UAV.

16. The method of claim 9, wherein the control signal sent from the mobile terminal to the UAV includes flight control instructions based on the relative coordinate data of the target object.

17. The method of claim 9, wherein the mobile terminal and the UAV are configured to be wirelessly communicated.

18. The method of claim 9, wherein transmitting captured image signal further comprises:
transmitting the image signal from the UAV to a ground receiver and relaying the image signal from the ground receiver to the mobile terminal.

19. An UAV-kit, comprising:
an UAV configured to capture an image and transmit an image signal;
a mobile terminal, wirelessly connected to the UAV, configured to execute a pattern recognition data processing based on the transmitted image signal and send a control signal sent to the UAV based on the pattern recognition data processing.

20. The UAV-kit of claim 17, further comprising a ground receiver configured to receive the image signal from the UAV and relaying the image signal to the mobile terminal.
